(19) United States
(12) Patent Application Publication
(10) Pub. No.: US 2010/0227646 A1
(43) Pub. Date: Sep. 9, 2010

(54) Mobile communication base station antenna

(75) Inventors: Tomoyuki Ogawa, Hitachi (JP); Shinsuke Murano, Kasama (JP); Osamu Tasaki, Hitachi (JP); Takayuki Shimizu, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 12/659,249

(22) Filed: Mar. 2, 2010

(30) Foreign Application Priority Data
Mar. 3, 2009 (JP) 2009-049435
Jun. 23, 2009 (JP) 2009-148225

(51) Int. Cl. H04M 1/00

(52) U.S. Cl. 455/562.1

(57) ABSTRACT

A mobile communication base station antenna has a plurality of array antennas. Each of the array antennas has an antenna element pair array including a plurality of antenna element pairs arranged in a vertical plane. Each of the antenna element pairs has two antenna elements having polarization characteristics orthogonal to each other. Two feeding points are provided for feeding an electric power to the two antenna elements respectively. The array antennas are arranged in a vertical plane, and the antenna element pairs included in one of the array antennas and the antenna element pairs included in other of the array antennas are arranged alternately, at least in a part between the array antennas adjacent to each other.

The present application is based on Japanese Patent Application No. 2009-049435 filed on Mar. 3, 2009 and Japanese Patent Application No. 2009-148225 filed on Jun. 23, 2009, the entire contents of which are incorporated herein by reference.

### BACKGROUND OF THE INVENTION

1. Field of the Invention

The present invention relates to a dual-polarized antenna and an array antenna, more particularly, to a mobile communication base station antenna for realizing a Space Division Multiple Access (SDMA).

2. Related Art

Technique such as Frequency Division Multiple Access (FDMA), Time Division Multiple Access (TDMA), or Code Division Multiple Access (CDMA) has been proposed to realize a simultaneous connection of plural users in a base station to be used for mobile communication, and has been introduced into commercial systems.

However, as a result of sudden increase of mobile communication users in accordance with spread of the mobile communication for late years, there is a problem in that the number of frequencies becomes short due to call requests more than capacity of frequency channels assigned to the mobile communication.

Therefore, the Space Division Multiple Access (SDMA), which realizes the communication with the users in one (single) frequency band, has been proposed so as to realize expansion of the channel capacity by increasing a utilization efficiency of the frequency. In the SDMA, the plural users are separated by difference in space, by turning a main beam orientation of a directivity of a base station antenna toward a desired user and turning a null orientation of the directivity of the base station antenna toward other users.

As a technique for realizing the SDMA, there is a radio communication technique called as MIMO (Multiple Input Multiple Output), in which a data transmission and reception band is broadened by combining plural antennas. In the MIMO, it is necessary to install plural antennas for dividing a transmission data into plural signals (streams) and simultaneously transmitting the divided signals.

Japanese Patent Laid-Open No. 2001-313525 (JP-A 2001-313525) proposes a mobile communication base station antenna for realizing the SDMA, in which plural array antennas are located linearly (on a straight line) or annularly (on a circumference of a circle) so as to improve resolution capability of the plural users.

In addition, K. Nishimori et al, “Channel Capacity Measurement of 8×2 MIMO Transmission by Antenna Configurations in an Actual Cellular Environment”, IEEE TRANSACTIONS ON ANTENNAS AND PROPAGATION, VOL. 54, No. 11, November, 2006, pp. 3285-3291 proposes a mobile communication base station for realizing the SDMA, in which four array antennas using V-H (vertical and horizontal) polarized wave and ±45 degree slant polarized wave are arranged in a horizontal direction.

However, in the conventional antenna devices proposed by JP-A 2001-313525 and Nishimori et al, there is a problem in that installation occupied area of the mobile communication base station antenna in total is increased since the array antennas are disposed linearly or annularly (on a circumference). In addition, when the array antennas are disposed linearly or annularly, there is another problem in that the installation occupied area of the mobile communication base station antenna is further increased since a large space (interval) between adjacent array antennas is required so as to obtain a space diversity effect.

As described above, there is the problem in that the installation occupied area of the antenna is increased when the MIMO is introduced so as to improve the utilization efficiency of the frequency, since the number of the array antennas should be increased. Further, there is a further problem in that a construction cost is increased when the number of the array antennas is increased, since installation work of respective array antennas and ancillary facilities of the respective array antennas such as cable are required in accordance with the number of the array antennas.

In late years, in accordance with spread of high-speed radio communication including portable telephone, the mobile communication base station antennas overflow all over the town. However, since the mobile communication base station antenna is generally installed on a steel tower or a roof of a high building, the increase in the number of the array antennas raises the cost for installation or damages the landscape, so that it is unfavorable to increase the number of the array antennas.

Therefore, it is indispensable to introduce the MIMO by arranging the plural array antennas so as to increase the channel capacity by improving the utilization efficiency of the frequency. However, since there is a request of avoiding the increase in the installation occupied area as much as possible, the mobile communication base station antenna with a small installation occupied area is strongly desired.

Yoshio Ebine et al “A Study of Vertical Space Diversity for a Land Mobile Radio”, The Institute of Electronics, Information and Communication Engineers (IEICE) Transactions, B-II No. 6, June, 1990, pp. 286-292 proposes a technique of reducing the antenna installation occupied area by perpendicularly arranging two reception antennas on a vertical axis to provide a vertical space diversity.

However, Ebine et al merely clarify the effectiveness of the vertical space diversity antenna theoretically and experimentally from the view point of the antenna interval (spacing) and an antenna correlation coefficient, and remain on verification of the space diversity effect thereof. In other words, Ebine et al do not mention about an array antenna structure for realizing the SDMA.

### SUMMARY OF THE INVENTION

Therefore, an object of the present invention is to solve the above problem and to provide a mobile communication base station antenna for realizing the SDMA without largely increasing the installation occupied area of the mobile communication base station antenna compared with that of the conventional device.

According to a feature of the invention, a mobile communication base station antenna comprises:

array antennas, each of the array antennas comprising an antenna element pair array including a plurality of antenna element pairs arranged in a vertical plane, each of the antenna element pairs comprising two antenna elements having polarization characteristics orthogonal to each other, and two feeding points for feeding an electric power to the two antenna elements respectively,

in which the array antennas are arranged in the vertical plane,

in which the antenna element pairs included in one of the array antennas and the antenna element pairs included in other of the array antennas are arranged alternately, at least in a part between the array antennas adjacent to each other.

In the mobile communication base station antenna, the antenna element pairs included in the one of the array antennas and the antenna element pairs included in the other of the array antennas may be arranged alternately over an entire part between the adjacent array antennas.

In the mobile communication base station antenna, the antenna element may comprise a horizontal-vertical polarization antenna element pair, in which one of the two antenna elements is horizontally disposed and other of the two antenna elements is vertically disposed.

In the mobile communication base station antenna, the antenna element may comprise a ±45 degree antenna element pair, in which one of the two antenna elements is slant with +45 degree to a vertical direction and other of the two antenna elements is slant with −45 degree to the vertical direction.

In the mobile communication base station antenna, at least one of the array antennas may comprise a horizontal-vertical polarization antenna element pair, in which one of the two antenna elements is horizontally disposed and other of the two antenna elements is vertically disposed, and other of the array antennas may comprise a ±45 degree antenna element pair, in which one of the two antenna elements is slant with +45 degree to a vertical direction and other of the two antenna elements is slant with −45 degree to the vertical direction.

In the mobile communication base station antenna, a horizontal-vertical polarization antenna element pair, in which one of the two antenna elements is horizontally disposed and other of the two antenna elements is vertically disposed, and a ±45 degree antenna element pair, in which one of the two antenna elements is slant with +45 degree to a vertical direction and other of the two antenna elements is slant with −45 degree to the vertical direction, may be arranged alternately in the array antenna.

In the mobile communication base station antenna, the antenna element pairs included in one of the array antennas and the antenna element pairs included in other of the array antennas may be distant from each other with a horizontal distance in a left and right direction when viewed from a front side of the antenna element pairs, at least in a part between the array antennas adjacent to each other.

In the mobile communication base station antenna, it is preferable that the horizontal distance is 10 mm or more and 40 mm or less.

In the mobile communication base station antenna, the antenna element may comprise a half wave dipole antenna.

In the mobile communication base station antenna, the antenna element may comprise a patch antenna.

### POINTS OF THE INVENTION

According to the present invention, it is possible to provide a mobile communication base station antenna for realizing the SDMA without largely increasing the installation occupied area of the mobile communication base station compared with the conventional system. It is possible to realize the SDMA in the vertical direction by disposing two or more array antennas in the vertical direction, thereby increasing the data communication capacity by the MIMO. Therefore, it is possible to realize the data communication with a speed higher than that of the conventional system.

### BRIEF DESCRIPTION OF THE DRAWINGS

Next, the mobile communication base station antenna in preferred embodiments according to the invention will be explained in conjunction with appended drawing, wherein:

FIG. 1 is a schematic diagram of the mobile communication base station antenna in the first preferred embodiment according to the invention;

FIGS. 2A and 2B are explanatory diagrams of a structure of the array antenna in the mobile communication base station antenna in the first preferred embodiment according to the invention as shown in FIG. 1, wherein FIG. 2A is a front view of the array antenna and FIG. 2B is a side view of the array antenna;

FIG. 3 is an explanatory diagram showing a perspective view of the array antenna in the mobile communication base station antenna in the first preferred embodiment shown in FIGS. 2A and 2B;

FIG. 4 is an explanatory diagram for explaining the antenna element structure by disassembling the array antennas in the mobile communication base station antenna in the first preferred embodiment;

FIGS. 5A and 5B are explanatory diagrams showing an adjustment of the antenna correlation coefficient by changing a ratio of an overlapped portion of the array antennas in the mobile communication base station antenna, in which FIG. 5A shows a case where the antenna correlation coefficient is large and FIG. 5B shows a case where the antenna correlation coefficient is small;

FIG. 6 is a schematic diagram of a mobile communication base station antenna in the second preferred embodiment according to the invention;

FIG. 7 is a schematic diagram of a mobile communication base station antenna in the third preferred embodiment according to the invention;

FIG. 8 is a schematic diagram of a mobile communication base station antenna in the fourth preferred embodiment according to the invention;

FIG. 9 is a schematic diagram of a mobile communication base station antenna in the fifth preferred embodiment according to the invention;

FIG. 10 is an explanatory diagram showing a horizontal distance d in a horizontal direction in the overlapped portion and a vertical distance D between adjacent antenna element pairs in the overlapped portion;

FIGS. 11A to 11C are diagrams showing a mobile communication base station antenna in Example 1, wherein FIG. 11A is a schematic diagram thereof, FIG. 11B is a graph showing an antenna element radiation gain in a horizontal plane thereof, and FIG. 11C is a graph showing an antenna element radiation gain in a vertical plane thereof;

FIGS. 12A to 12C are diagrams showing a mobile communication base station antenna in Example 2, wherein FIG. 12A is a schematic diagram thereof, FIG. 12B is a graph showing an antenna element radiation gain in a horizontal plane thereof, and FIG. 12C is a graph showing an antenna element radiation gain in a vertical plane thereof;

FIGS. 13A to 13C are diagrams showing a mobile communication base station antenna in Example 3, wherein FIG. 13A is a schematic diagram thereof, FIG. 13B is a graph showing an antenna element radiation gain in a horizontal plane thereof, and FIG. 13C is a graph showing an antenna element radiation gain in a vertical plane thereof;

FIGS. 14A to 14C are diagrams showing the mobile communication base station antenna in Example 4, wherein FIG. 14A is a schematic diagram thereof, FIG. 14B is a graph showing an antenna element radiation gain in a horizontal plane thereof, and FIG. 14C is a graph showing an antenna element radiation gain in a vertical plane thereof;

FIGS. 15A and 15B are explanatory diagrams of the mobile communication base station antenna, wherein FIG. 15A shows coordinate axes and a front view thereof, and FIG. 15B shows coordinate axes and a side view thereof;

FIGS. 16A and 16B are explanatory diagrams of beam tilt in the mobile communication base station antenna, wherein FIG. 16A shows a horizontal plane beam tilt, and FIG. 16B shows a vertical plane beam tilt;

FIGS. 17A and 17B are explanatory diagrams of HPBW in the mobile communication base station antenna, wherein FIG. 16A shows a horizontal plane HPBW, and FIG. 16B shows a vertical plane HPBW;

FIG. 18A is an explanatory diagram showing a method for measuring an antenna element radiation gain in the mobile communication base station antenna;

FIG. 18B is a graph showing a measuring result of the antenna element radiation gain in the mobile communication base station antenna;

FIG. 19 is a schematic diagram of a mobile communication base station antenna in the sixth preferred embodiment according to the present invention;

FIG. 20 is a schematic diagram of a mobile communication base station antenna in the seventh preferred embodiment according to the present invention; and

FIG. 21 is a schematic diagram of a mobile communication base station antenna in the eighth preferred embodiment according to the present invention.

### DETAILED DESCRIPTION OF THE PREFERRED EMBODIMENTS

Next, the preferred embodiments according to the present invention will be explained below in more detail in conjunction with appended drawings.

The mobile communication base station antenna according to the present invention realizes the SDMA and realizes the MIMO, in which the plural antennas are combined to broaden the communication capacity for the data transmission and reception.

### First Preferred Embodiment

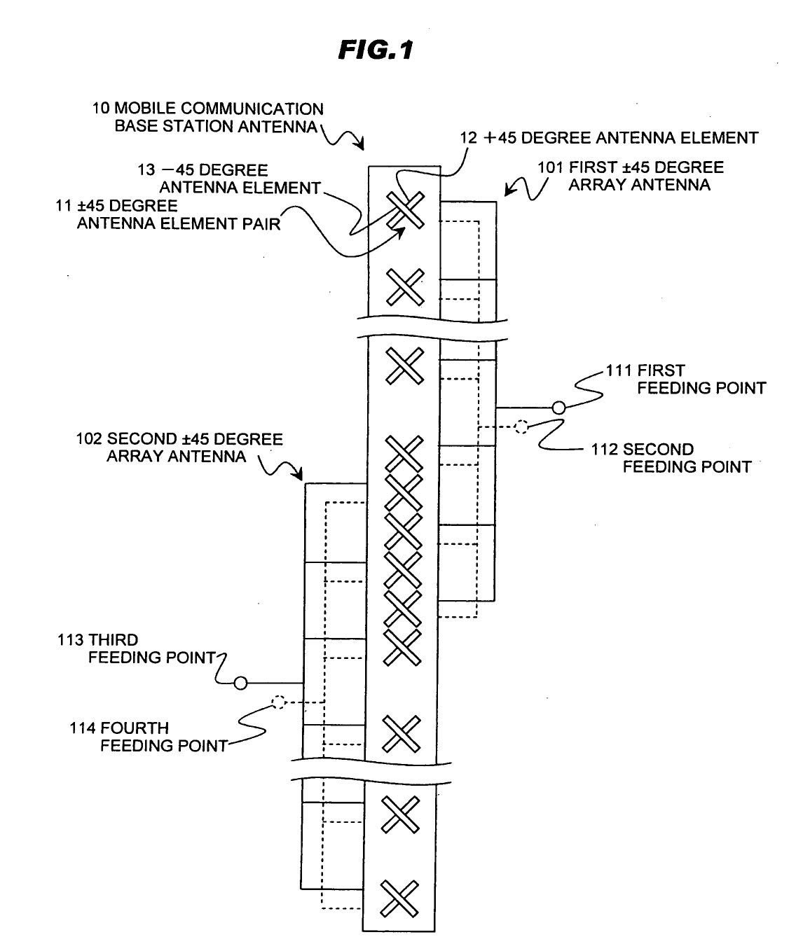

FIG. 1 is a schematic diagram of the mobile communication base station antenna in the first preferred embodiment according to the invention.

As shown in FIG. 1, a mobile communication base station antenna 10 comprises two or more array antennas (a first ±45 degree array antenna 101 and a second ±45 degree array antenna 102 in FIG. 1), and respective array antennas 101, 102 are arranged in a vertical plane. The mobile communication base station antenna 10 is such configured that antenna element pairs included in one of adjacent array antennas and antenna element pairs included in the other one of the adjacent array antenna included are alternately arranged at least in a part between the adjacent array antennas. In this embodiment, a case where two array antennas (±45 degree array antennas) 101, 102 are arranged in the vertical plane as shown in FIG. 1 will be explained.

In the ±45 degree array antennas 101, 102 that are the two array antennas, a plurality of antenna element pairs (±45 degree antenna element pairs) 11 are linearly arranged in the vertical plane. The antenna element pair (±45 degree antenna element pair) 11 comprises two antenna elements (+45 degree antenna element and −45 degree antenna element) 12, 13 that are disposed to be orthogonal to each other and polarization characteristics of which are orthogonal to each other.

In this embodiment, the antenna element pair 11 is a ±45 degree antenna element pair 11, in which one antenna element (+45 degree antenna element) 12 is inclined at an angle of +45 degrees with respect to the vertical plane and the other antenna element (−45 degree antenna element) 13 is inclined at an angle of −45 degrees with respect to the vertical plane. In other words, the mobile communication base antenna in this embodiment is a dual-polarized antenna, in which +45 degree polarized wave and −45 degree polarized wave are dually used in one antenna.

Further, in this embodiment, an electric power is fed from a first feeding point 111 to the +45 degree antenna element 12 composing the ±45 degree array antenna 101, fed from a second feeding point 112 to the −45 degree antenna element 13 composing the ±45 degree array antenna 101, fed from a third feeding point 113 to the +45 degree antenna element 12 composing the ±45 degree array antenna 102, and fed from a fourth feeding point 114 to the −45 degree antenna element 13 composing the ±45 degree array antenna 102.

Herein, the −45 degree antenna element 13 is expressed in a broken line to be distinguished from the +45 degree antenna element 12 definitely. The second feeding point 112 and a feeding line connected to the second feeding point 112 are expressed in a broken line to be distinguished from the first feeding point 111 and a feeding line connected to the first feeding point 111 definitely. The fourth feeding point 114 and a feeding line connected to the fourth feeding point 114 are expressed in broken line to be distinguished from the third feeding point 113 and a feeding line connected to the third feeding point 113 definitely. Similarly, the broken line is used as means for distinguishing the antenna element and the feeding points that are close to each other definitely in following explanation.

### (Structure of the Antenna Element Pair)

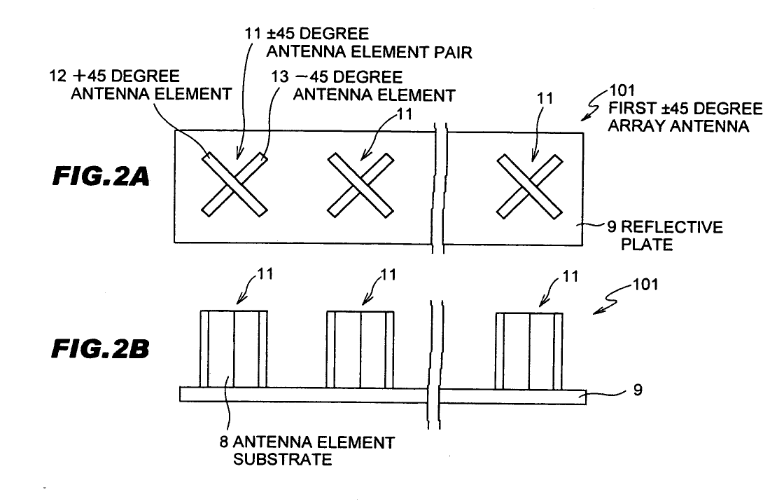

FIGS. 2A and 2B are explanatory diagrams of a structure of the array antenna in the mobile communication base station antenna in the first preferred embodiment according to the invention as shown in FIG. 1, wherein FIG. 2A is a front view of the array antenna and FIG. 2B is a side view of the array antenna.

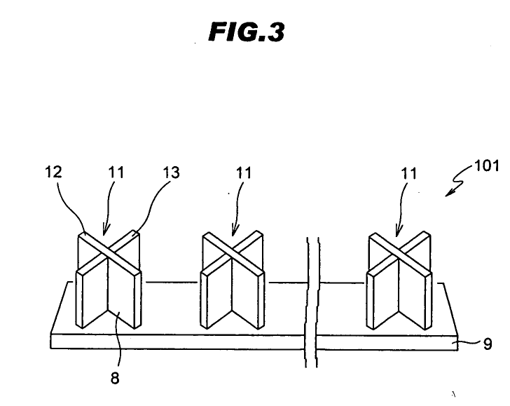

FIG. 3 is an explanatory diagram showing a perspective view of the array antenna in the mobile communication base station antenna in the first preferred embodiment shown in FIGS. 2A and 2B.

As shown in FIGS. 2A-2B and FIG. 3, the antenna element pairs (±45 degree antenna element pairs) 11 are disposed in the array shape along a longitudinal direction of a reflective plate 9. The antenna element pairs (±45 degree antenna element pairs) 11 are construed by combining the antenna elements (+45 degree antenna element and −45 degree antenna element) 12, 13 to have a cross-shape in its cross sectional view. Each of the +45 degree antenna element 12 and −45 degree antenna element 13 is construed by forming an antenna element pattern (not shown) comprising a metal on a surface of an antenna element substrate 8. It is possible to transmit and receive electric waves as +45 degree polarized wave and −45 degree polarized wave in dual mode by the ±45 degree antenna element pairs 11. The +45 degree antenna element 12 and the −45 degree antenna element 13 are respectively connected to different feeding points (not shown in FIGS. 2A-2B and FIG. 3) via feeding lines.

Further, in this embodiment, the +45 degree antenna element 12 composing the ±45 degree array antenna 101 is connected to the first feeding point 111 by a feeding line expressed in a solid line, the −45 degree antenna element 13 composing the ±45 degree array antenna 101 is connected to the second feeding point 112 by a feeding line expressed in a broken line, the +45 degree antenna element 12 composing the ±45 degree array antenna 102 is connected to the third feeding point 113 by a feeding line expressed in a solid line, and the −45 degree antenna element 13 composing the ±45 degree array antenna 102 is connected to the fourth feeding point 114 by a feeding line expressed in a broken line.

Further, in this preferred embodiment, a half wave dipole antenna is used as the antenna element, namely, +45 degree antenna element 12 and −45 degree antenna element 13. However, the antenna elements are not limited to the half wave dipole antenna. A patch antenna and other polarized wave diversity antenna elements may be used.

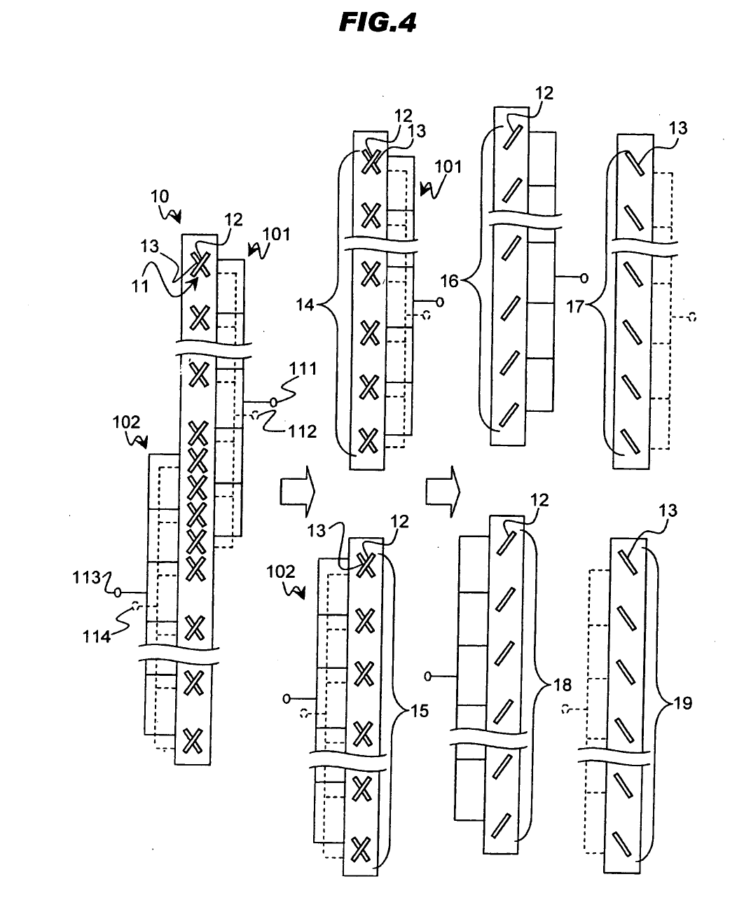

FIG. 4 is an explanatory diagram for explaining the antenna element structure by disassembling the array antennas in the mobile communication base station antenna 10 in the first preferred embodiment.

Referring to FIG. 4, the mobile communication base station antenna 10 is divided into two ±45 degree array antennas 101, 102, and each of the ±45 degree array antennas 101, 102 is divided into antenna element arrays each comprising a plurality of antenna elements (+45 degree antenna element 12 and −45 degree antenna element 13) in accordance with polarization angles, so as to explain the mobile communication base station antenna 10 more clearly.

As shown in FIG. 4, the mobile communication base station antenna 10 comprises antenna element arrays (+45 degree antenna element arrays 16, 18) in which a plurality of antenna elements (+45 degree antenna element 12) are linearly arranged in the vertical plane, and antenna element arrays (−45 degree antenna element arrays 17, 19) in which a plurality of antenna elements (−45 degree antenna element 13) are linearly arranged in the vertical plane. The +45 degree antenna element array 16 and the −45 degree antenna element array 17 are superimposed each other, and the +45 degree antenna element array 18 and the −45 degree antenna element array 19 are superimposed each other, to provide antenna element pair arrays (±45 degree antenna element pair arrays 14, 15), in which a plurality of antenna element pairs (±45 degree antenna element pair 11) as elements of a polarized wave diversity antenna are linearly arranged in the vertical plane. The mobile communication base station antenna 10 is formed by arranging antenna element pairs included in one of the adjacent ±45 degree array antennas 101, 102 and antenna element pairs included in the other one of the adjacent ±45 degree array antennas 101, 102 are alternately arranged at least in a part between the adjacent ±45 degree array antennas 101, 102.

Dimensions of each of the antenna elements (+45 degree antenna element and −45 degree antenna element) 12, 13 may be appropriately determined in accordance with the frequency and the bandwidth to be used. In addition, the number of the antenna element pairs (±45 degree antenna element pairs) 11 may be appropriately determined in accordance with a desired antenna specification such as antenna transmission gain or beam width of the antenna.

Since the mobile communication base station antenna 10 composes a ±45 degree slant diversity antenna, an antenna correlation coefficient between the antenna element arrays polarization characteristic of which are orthogonal to each other, namely, between the +45 degree antenna element array 16 and the −45 degree antenna element array 17, and between the +45 degree antenna element array 18 and the −45 degree antenna element array 19 ideally approximates zero (0). Therefore, it is possible to obtain the same effect as providing two slant diversity antennas of an ordinary type, by using one of the first and second array antennas 2A, 2B as a dual-polarized antenna. Therefore, it is possible to realize 2MIMO antenna structure.

For using the plural array antennas, there is a problem of the antenna correlation coefficient between the two respective array antennas. If the antenna correlation coefficient is large, a correlation between signals received at the respective array antennas (i.e. between the ±45 degree array antennas 101, 102) will be increased. As a result, it is not possible to provide a sufficient enhancement in the communication capacity.

### (Adjustment of the Antenna Correlation Coefficient)

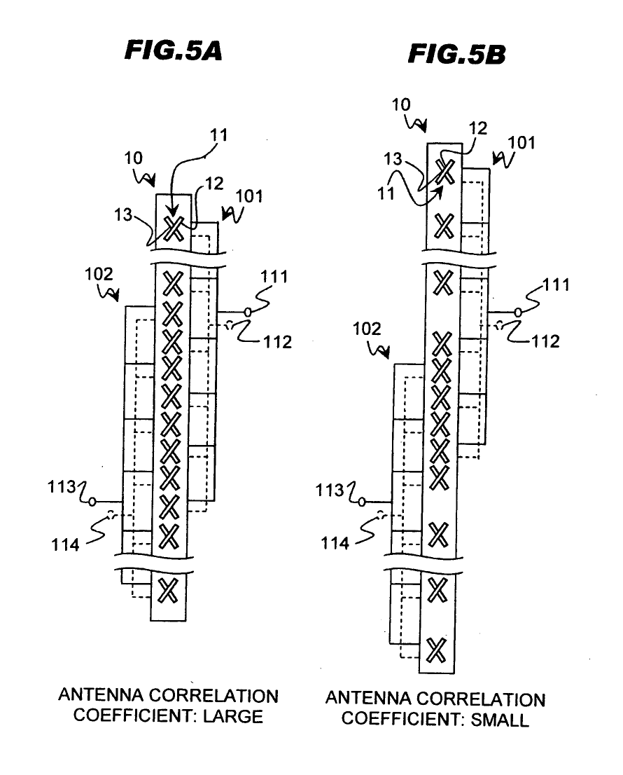

FIGS. 5A and 5B are explanatory diagrams showing an adjustment of the antenna correlation coefficient by changing a ratio of an overlapped portion of the array antennas in the mobile communication base station antenna, in which FIG. 5A shows a case where the antenna correlation coefficient is large and FIG. 5B shows a case where the antenna correlation coefficient is small.

As shown in FIGS. 5A and 5B, the antenna correlation coefficient can be adjusted by changing a ratio of an area of the overlapped portion between the array antennas (±45 degree array antennas 101,102) to a total area of the mobile communication base station antenna 10 (hereinafter, referred to as “ratio of the overlapped portion”). The overlapped portion is a part in which the antenna element pairs 11 included in the ±45 degree array antenna 101 and the antenna element pairs 11 included in the ±45 degree array antenna 102 are arranged alternately.

Referring to FIG. 5A, when the ratio of the overlapped portion between both array antennas (±45 degree array antennas 101, 102) is large, the antenna correlation coefficient is increased. It is unfavorable for firmly obtaining a larger communication capacity. However, it is favorable for downsizing (since a common parts between the ±45 degree array antennas 101, 102 is increased) and for reducing the weight, and for reducing the cost in accordance with the downsizing and the reduction in weight. On the other hand, when the ratio of the overlapped portion between the both array antennas (±45 degree array antennas 101, 102) is small, the antenna correlation coefficient is decreased. It is unfavorable for downsizing (since a common parts between the ±45 degree array antennas 101, 102 is increased) and for reducing the weight, and for reducing the cost in accordance with the downsizing and the reduction in weight. However, it is favorable for firmly obtaining a larger communication capacity.

Therefore, it is the ratio of the overlapped portion may be determined appropriately with considering an environment in which the mobile communication base station antenna will be installed, a required communication capacity and the like.

In this embodiment, the case of using the two array antennas (±45 degree array antennas 101, 102) is explained. However, the number of the array antennas in the present invention is not limited to two (2). It is sufficient to provide two or more array antennas.

### (Function and Effects of the First Embodiment)

Next, functions of the mobile communication base station antenna 10 in this preferred embodiment will be explained below.

In this embodiment, the mobile communication base station antenna 10 comprises two or more array antennas 101, 102 in which a plurality of antenna element pairs (±45 degree antenna element pairs) 11 comprising antenna elements (+45 and −45 degree antenna elements) 12, 13 having polarization characteristics orthogonal to each other are arranged in the vertical plane, and the respective array antennas 101, 102 are arranged in the vertical plane. In FIG. 1, only the ±45 degree array antennas 101, 102 are shown. However, the number thereof is not limited to two. It is sufficient to provide two or more array antennas. An arrangement interval is not limited to a particular interval. The arrangement may be realized with a predetermined interval in accordance with desired antenna characteristics.

It is possible to realize the SDMA in the vertical direction without largely increasing the installation occupied area by arranging the two or more array antennas in the vertical direction (in the vertical plane). Therefore, it is possible to increase the data communication capacity by MIMO, thereby realizing the high-speed data communication compared with the conventional system.

Further, it is not necessary to install an extra antenna (array antenna), since the two or more array antennas are arranged in the vertical direction to provide the mobile communication base station antenna 10. Therefore, addition of mechanical installation mechanism such as pole brace for exclusive use in antenna installation or installation metal fitting is minimized or no longer necessary, thereby reducing the cost.

Still further, in this embodiment, it is possible to realize numerous MIMO antennas without largely increasing the installation occupied area.

Next, mobile communication base station antennas in other embodiments will be explained.

### Second Embodiment

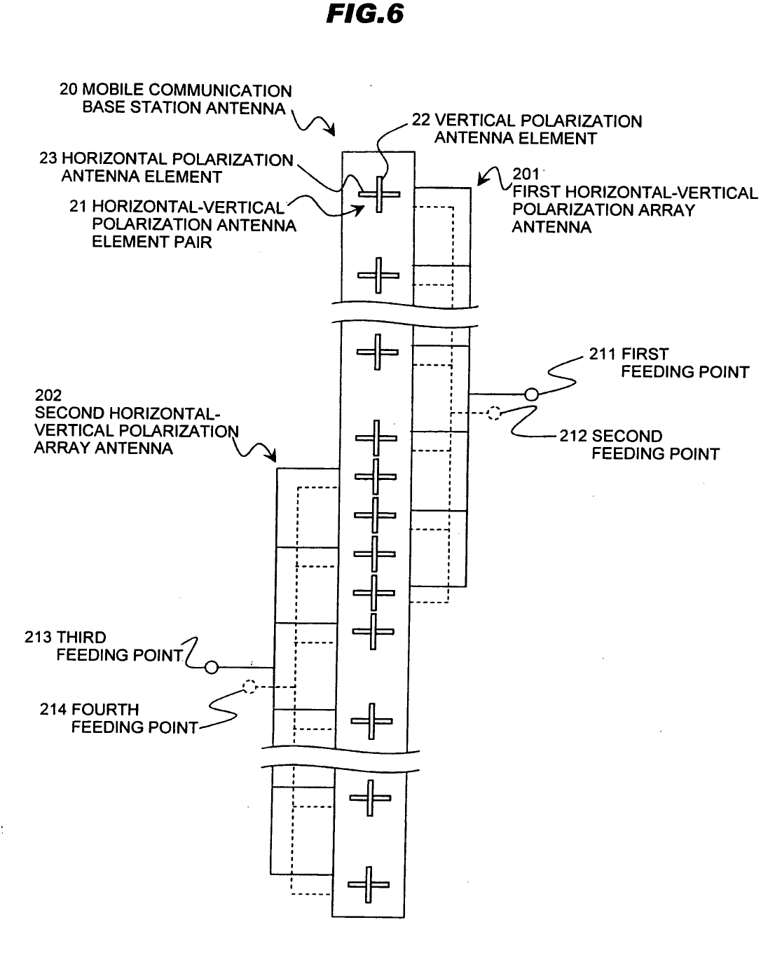

FIG. 6 is a schematic diagram of a mobile communication base station antenna in the second preferred embodiment according to the invention.

Referring to FIG. 6, a mobile communication base station antenna 20 is similar to the mobile communication base station antenna 10 of FIG. 1, except that the array antennas (±45 degree array antennas) 101, 102 in which the ±45 degree antenna element pairs 11 are linearly arranged in the vertical plane are replaced with array antennas (horizontal-vertical polarization array antennas) 201, 202 in which horizontal-vertical polarization antenna element pairs 21 are linearly arranged in the vertical plane. The horizontal-vertical polarization antenna element pair 21 comprises a combination of one antenna element (vertical polarization antenna element) 22 arranged in the vertical direction and another antenna element (horizontal polarization antenna element) 23 in the horizontal direction.

In this embodiment, an electric power is fed from a first feeding point 211 to the vertical polarization antenna element 22 composing the horizontal-vertical polarization array antenna 201 by a feeding line expressed in a solid line, fed from a second feeding point 212 to the horizontal polarization antenna element 23 composing the horizontal-vertical polarization array antenna 201 by a feeding line expressed in a broken line, fed from a third feeding point 213 to the vertical polarization antenna element 22 composing the horizontal-vertical polarization array antenna 202 by a feeding line expressed in a solid line, and fed from a fourth feeding point 214 to the horizontal polarization antenna element 23 composing the horizontal-vertical polarization array antenna 202 by a feeding line expressed in a broken line.

### (Function and Effects of the Second Embodiment)

Since the mobile communication base station antenna 20 is similar to the mobile communication base station antenna 10 of FIG. 1 except that the ±45 degree antenna element pairs 11 are changed into the horizontal-vertical polarization antenna element pairs 21, functions and effects similar to those of the mobile communication base station antenna 10 of FIG. 1 can be obtained.

### Third Embodiment

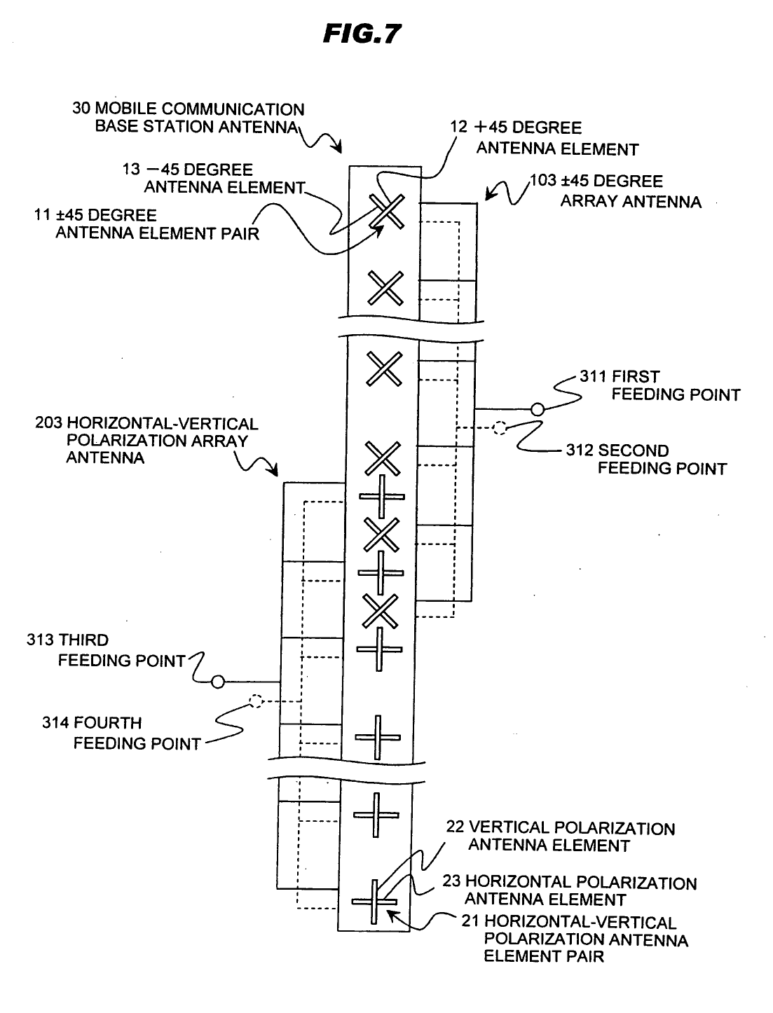

FIG. 7 is a schematic diagram of a mobile communication base station antenna in the third preferred embodiment according to the invention.

Referring to FIG. 7, a mobile communication base station antenna 30 is similar to the mobile communication base station antenna 10 of FIG. 1, except that an array antennas (±45 degree array antenna) 103 in which the ±45 degree antenna element pairs 11 are linearly arranged in the vertical plane and an array antenna (horizontal-vertical polarization array antenna) 203 in which the horizontal-vertical polarization antenna element pairs 21 are linearly arranged in the vertical plane are arranged in the same vertical plane.

In this embodiment, an electric power is fed from the first feeding point 311 to the +45 degree antenna element 12 composing the ±45 degree array antenna 103 by a feeding line expressed in a solid line, fed from the second feeding point 312 to the −45 degree antenna element 13 composing the ±45 degree array antenna 103 by a feeding line expressed in a broken line, fed from the third feeding point 313 to the vertical polarization antenna element 22 composing the horizontal-vertical polarization array antenna 203 by a feeding line expressed in a solid line, and fed from the fourth feeding point 314 to the horizontal polarization antenna element 23 composing the horizontal-vertical polarization array antenna 203 by a feeding line expressed in a broken line.

### (Function and Effects of the Third Embodiment)

Since a polarization direction of the ±45 degree array antenna 103 and a polarization direction of the horizontal-vertical polarization array antenna 203 are different from each other, when the ±45 degree array antenna 103 and the horizontal-vertical polarization array antenna 203 are arranged to be adjacent to each other, it is possible to decrease the antenna correlation coefficient between the array antennas 103, 203 (the ±45 degree array antenna 103 and the horizontal-vertical polarization array antenna 203), compared with the mobile communication base station antenna 10 in which the ±45 degree array antennas are adjacently arranged and the mobile communication base station antenna 20 in which the horizontal-vertical polarization array antennas are adjacently arranged. Therefore, it is possible to increase the ratio of the overlapped portion between the ±45 degree array antenna 103 and the horizontal-vertical polarization array antenna 203, thereby reducing dimension in the vertical direction (in vertical plane) of the mobile communication base station antenna 30.

Although FIG. 7 shows the case of using one ±45 degree array antenna 103 and one horizontal-vertical polarization array antenna 203, the present invention is not limited thereto. The number of the ±45 degree array antennas 103 may be different from the number of the horizontal-vertical polarization array antennas 203.

### Fourth Embodiment

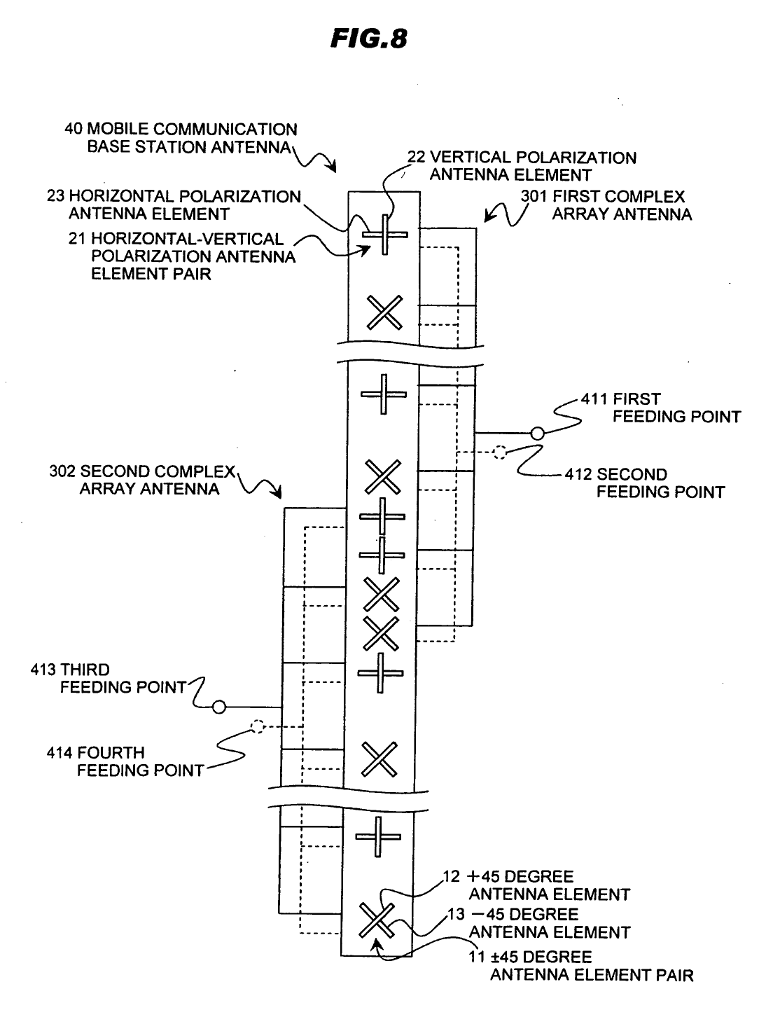

FIG. 8 is a schematic diagram of a mobile communication base station antenna in the fourth preferred embodiment according to the invention

Referring to FIG. 8, a mobile communication base station antenna 40 comprises array antennas (complex array antennas) 301, 302, in which the horizontal-vertical polarization antenna element pair 21 and the ±45 degree antenna element pairs 11 are arranged alternately, and two array antennas (complex array antennas) 301, 302 are arranged in the vertical direction (in the vertical plane).

In this embodiment, an electric power is fed from a first feeding point 411 to the +45 degree antenna element 12 and the vertical polarization antenna element 22 composing the complex array antenna 301 by a feeding line expressed in a solid line, fed from a second feeding point 412 to the −45 degree antenna element 13 and the horizontal polarization antenna element 23 composing the complex array antenna 301 by a feeding line expressed in a broken line, fed from a third feeding point 413 to the +45 degree antenna element 12 and the vertical polarization antenna element 22 composing the complex array antenna 302 by a feeding line expressed in a solid line, and fed from a fourth feeding point 414 to the −45 degree antenna element 13 and the horizontal polarization antenna element 23 composing the complex array antenna 302 by a feeding line expressed in a broken line.

### (Function and Effect of the Fourth Embodiment)

Even though the mobile communication base station antenna 40 is configured as shown in FIG. 8, functions and effects similar to those of the mobile communication base station antenna 10 of FIG. 1 can be obtained.

In aforementioned embodiments, a plurality of array antennas are linearly arranged in the vertical plane. However, the present invention is not limited thereto. By way of example only, antenna element pairs included in one of the adjacent array antennas and antenna element pairs included in the other of the adjacent array antennas may be arranged with an interval in a horizontal direction (hereinafter, referred to as “horizontal distance”) in a left and right direction when viewed from a front side of the antenna element pairs (hereinafter, referred to as “left and right direction”), at least in a part between the adjacent array antennas.

Next, a mobile communication base station antenna as described above will be explained.

### Fifth Embodiment

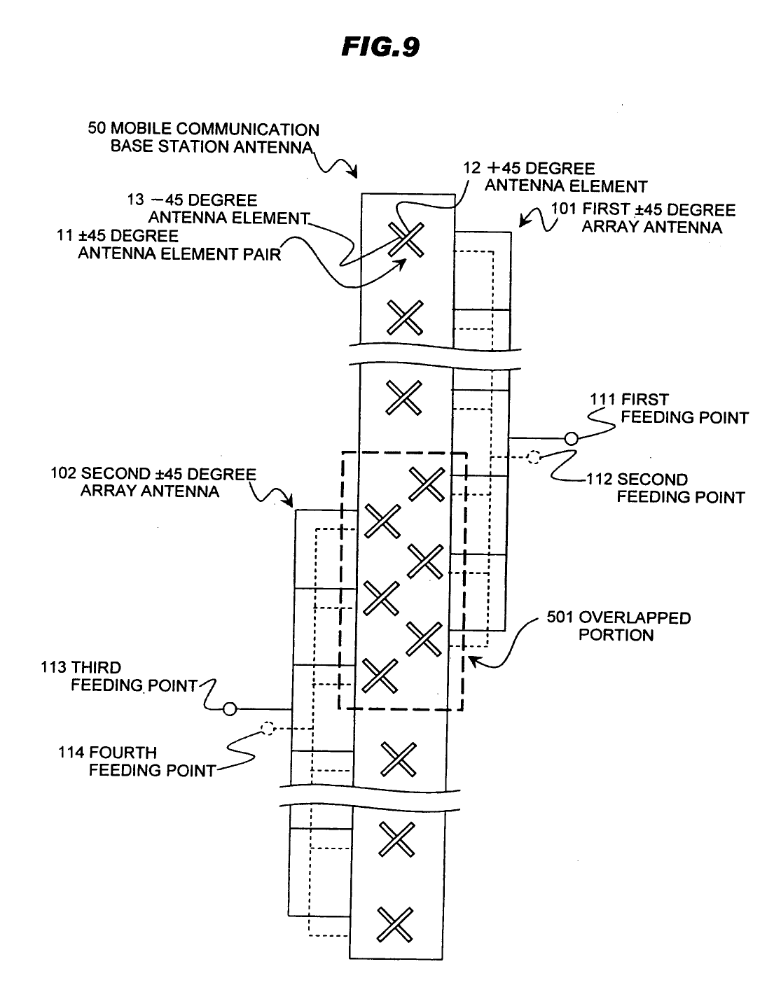

FIG. 9 is a schematic diagram of a mobile communication base station antenna in the fifth preferred embodiment according to the invention.

Referring to FIG. 9, a mobile communication base station antenna 50 is different from the mobile communication base station antenna 10 of FIG. 1 comprising the ±45 degree antenna element pairs 11 linearly arranged in the vertical plane, in that antenna element pairs (±45 degree antenna element pairs 11) included in one of the adjacent array antennas (i.e. ±45 degree array antenna 101) and antenna element pairs (±45 degree antenna element pairs 11) included in the other of the adjacent array antennas (±45 degree array antenna 102) may be arranged with a horizontal distance in a left and right direction when viewed from a front side of the antenna element pairs 11, in an overlapped portion 501 in which the ±45 degree antenna element pairs 11 included in the ±45 degree array antenna 101 and the ±45 degree antenna element pairs 11 included in the ±45 degree array antenna 102 are alternately arranged.

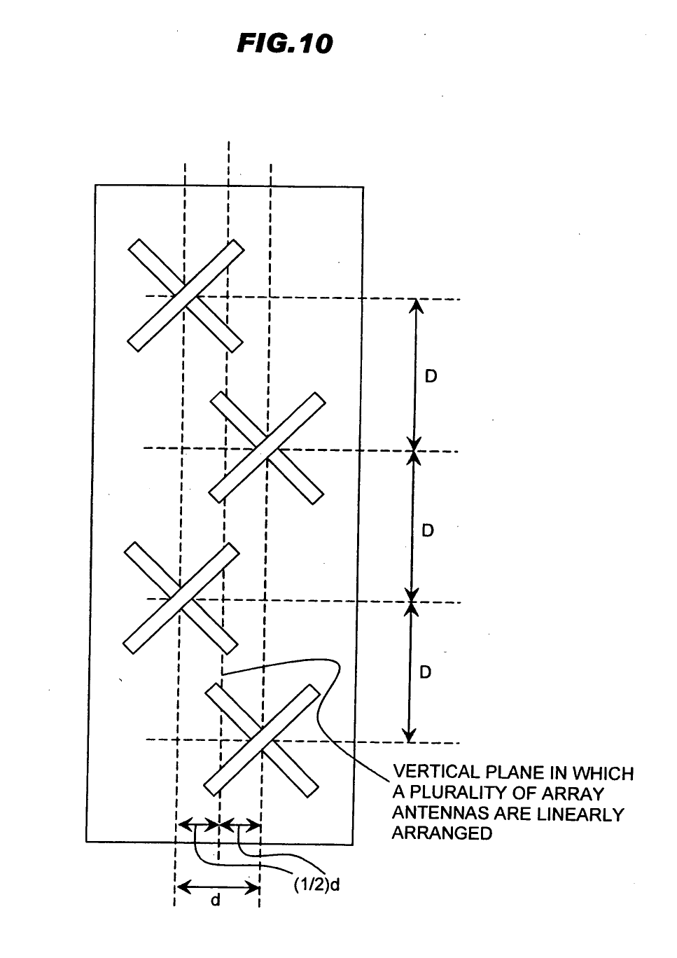

FIG. 10 is an explanatory diagram showing a horizontal distance d in a horizontal direction in the overlapped portion 501 and a vertical distance D between adjacent antenna element pairs in the overlapped portion 501.

Referring to FIG. 10, the horizontal distance d is an interval between intersections (crossing points) of respective antenna element pairs in a horizontal direction, and the vertical distance D is an interval between the intersections of the respective antenna element pairs. In the mobile communication base station antenna 50 shown in FIG. 9, a horizontal distance from the intersection of each of the antenna element pairs 11 arranged to be distant from each other in the left and right direction to the vertical plane in which a plurality of the array antennas 101, 102 are linearly arranged is set to be a half of the horizontal distance d (i.e. (½)d). However, the present invention is not limited thereto. The horizontal distance from the intersection of each of the antenna element pairs 11 arranged to be distant from each other in the left and right direction to the vertical plane in which a plurality of the array antennas 101, 102 are linearly arranged may be varied from each other.

### Examples

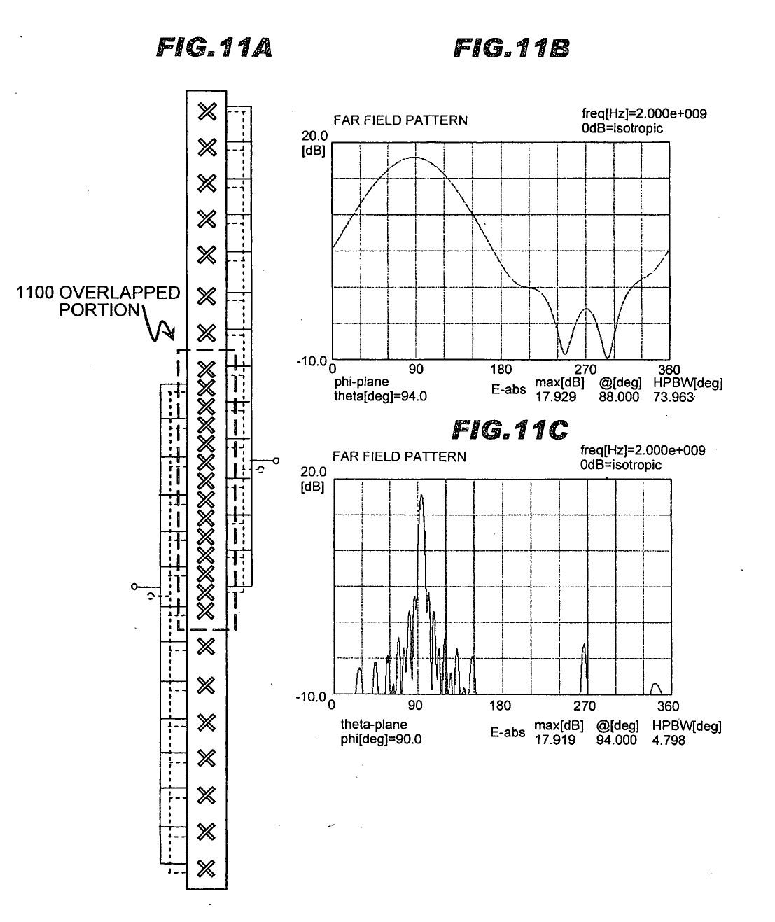

FIGS. 11A, 12A, 13A and 14A are schematic diagrams showing mobile communication base station antennas in Examples 1 to 4 in the embodiment according to the invention.

In Examples 1 to 4, the number n of the antenna element pairs in respective overlapped portions 1100, 1200, 1300 and 1400 and the horizontal distance d in the left and right direction between the antenna element pair included in one of the adjacent array antennas and the antenna element pair included in the other of the adjacent array antennas (referred to as “the horizontal distance in the left and right direction”) are changed, respectively.

TABLE 1 shows the number n and the horizontal distance d in the left and right direction in the mobile communication base station antennas shown in FIGS. 11A, 12A, 13A and 14A. The mobile communication base station antennas shown in FIGS. 11A, 12A, 13A and 14A are commonly configured to have a total number N (N=28) of the antenna element pairs, and a horizontal distance D (D=0.39 λmm, wherein λ is 2 GHz) between the adjacent antenna element pairs in the vertical direction in the respective overlapped portions 1100, 1200, 1300 and 1400.

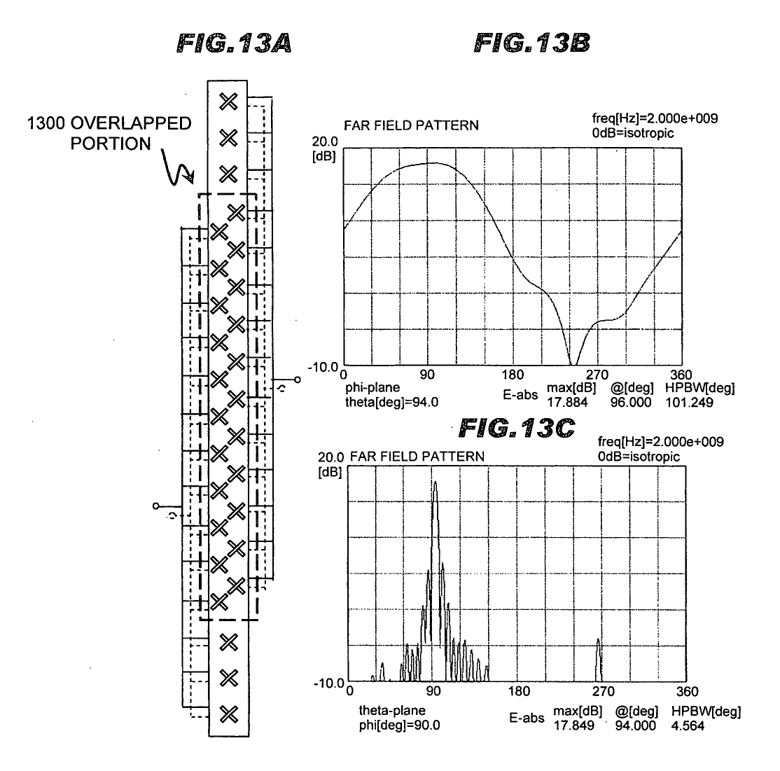

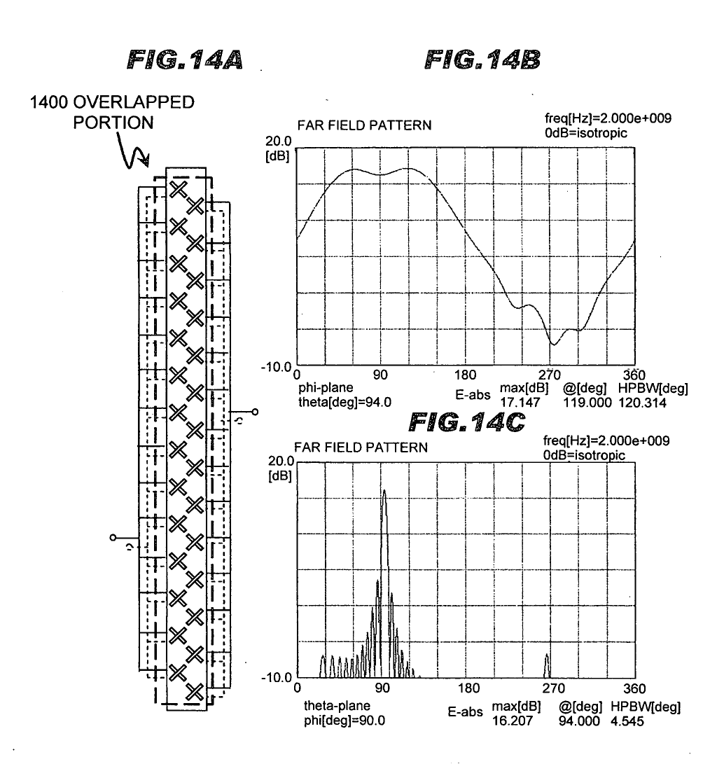

TABLE 1

| | Example 1 | Example 2 | | |
|---|---|---|---|---|
| | (FIG. | (FIG. | Example 3 | Example 4 |
| | 11A) | 12A) | (FIG. 13A) | (FIG. 14A) |
| The number n of the | 14 | 14 | 22 | 28 |
| antenna element | | | | |
| pairs in the | | | | |
| overlapped | | | | |
| portion (pcs) | | | | |
| The horizontal | 0 | 40 | 40 | 40 |
| distance d in the | | | | |
| left and right | | | | |
| direction (mm) | | | | |

FIGS. 11B, 12B, 13B and 14B are graphs showing simulation results of the antenna element radiation gain in the horizontal plane of the respective mobile communication base station antennas in Examples 1 to 4, and FIGS. 11C, 12C, 13C and 14C are graphs showing simulation results of the antenna element radiation gain in the vertical plane thereof.

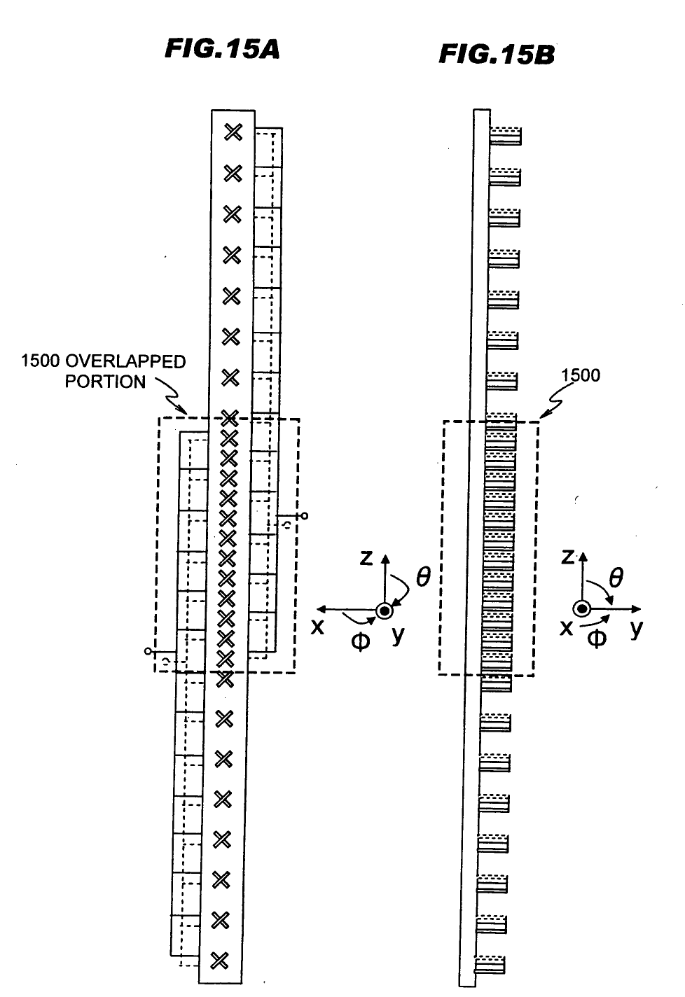

In FIGS. 11B, 12B, 13B and 14B, a vertical axis shows the horizontal plane radiation gain and a horizontal axis shows an angle in xy plane (horizontal angle φ) when coordinate axes shown in FIG. 15 are used. In FIGS. 11C, 12C, 13C and 14C, a vertical axis shows the vertical plane radiation gain and a horizontal axis shows an angle in yz plane (vertical angle θ) when the coordinate axes shown in FIG. 15 are used.

TABLE 2 shows summary of the simulation results.

TABLE 2

| | Exam- | Exam- | | |
|---|---|---|---|---|
| | ple 1 | ple 2 | Example 3 | Example 4 |
| Peak radiation gain absolute | 17.9 | 18.8 | 17.9 | 17.1 |
| value in the horizontal plane | | | | |
| (dBi) | | | | |
| Beam tilt angle in the | 2 | 1 | 6 | 29 |
| horizontal plane (degree) | | | | |
| Half-power bandwidth | 74 | 78 | 101 | 120 |
| (HPBW) in the horizontal | | | | |
| plane (degree) | | | | |
| Peak radiation gain absolute | 17.9 | 18.8 | 17.8 | 16.2 |
| value in the vertical | | | | |
| plane (dBi) | | | | |
| Beam tilt angle in the vertical | 4 | 4 | 4 | 4 |
| plane (degree) | | | | |
| Half-power bandwidth | 4.8 | 4.7 | 4.6 | 4.5 |
| (HPBW) in the vertical | | | | |
| plane (degree) | | | | |

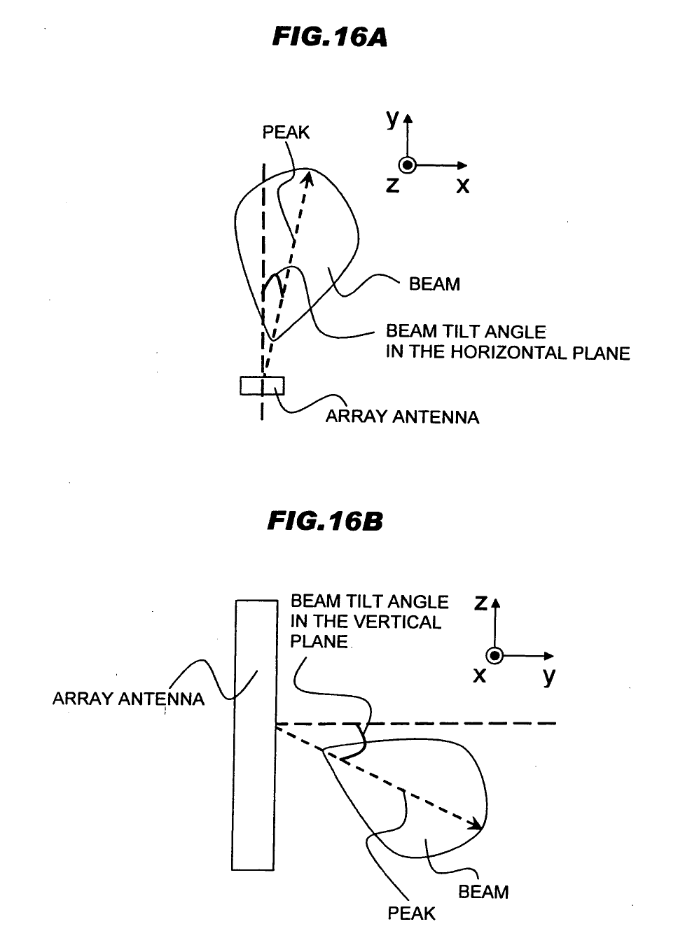

In TABLE 2, the “beam tilt” is an angle made by a peak of a beam (electric wave) radiated from the array antenna and a plane defined on the basis of the array antenna. The “beam tilt angle in the horizontal plane” is an angle made by the peak of the beam radiated from the array antenna and the horizontal plane (xy plane) of the array antenna as shown in FIG. 16A. The “beam tilt angle in the vertical plane” is an angle made by the peak of the beam radiated from the array antenna and the vertical plane (yz plane) of the array antenna as shown in FIG. 16B.

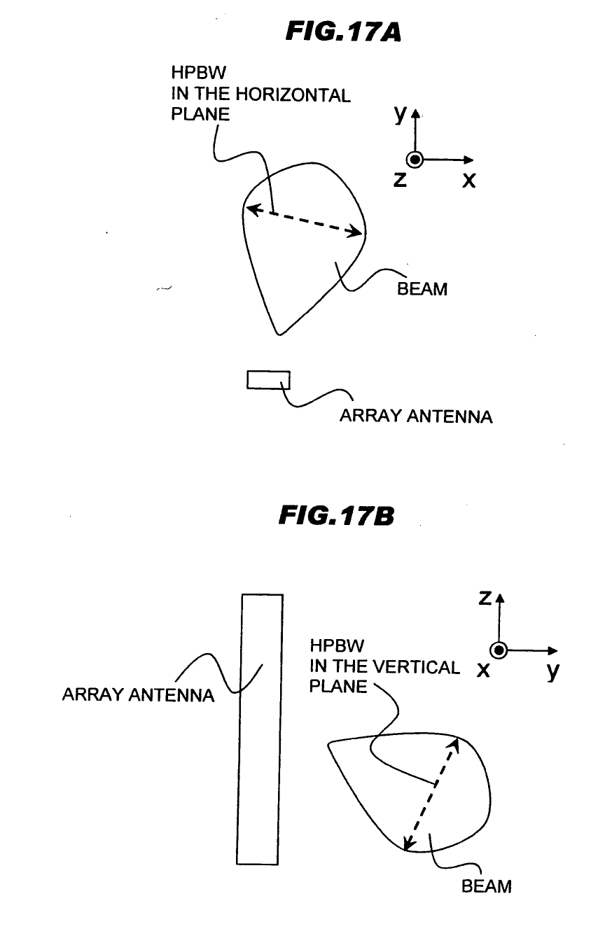

In TABLE 2, the “half-power bandwidth (HPBW)” is a half value of the beam (electric wave) radiated from the array antenna. The “half-power bandwidth (HPBW) in the horizontal plane” is a half value of the beam radiated from the array antenna in the horizontal plane (xy plane) of the array antenna as shown in FIG. 17A. The “half-power bandwidth (HPBW) in the vertical plane” is a half value of the beam radiated from the array antenna in the vertical plane (yz plane) of the array antenna as shown in FIG. 17B.

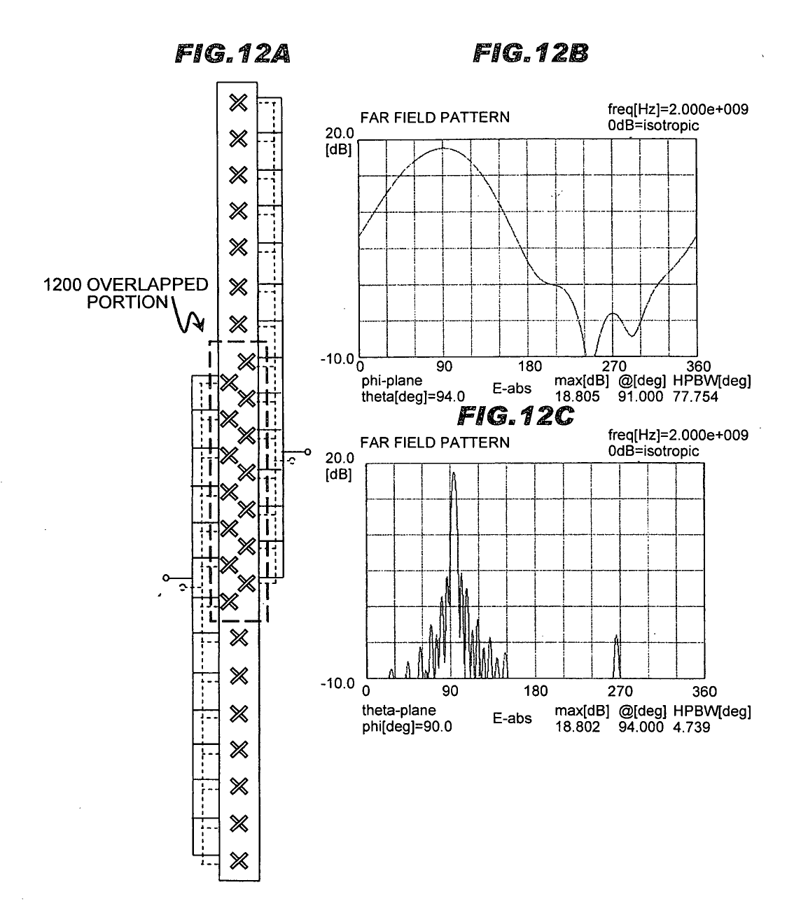

As clearly understood from the simulation results shown in TABLE 2, in the mobile communication base station antenna of FIG. 12A in Example 2, the radiation gains (the peak radiation gain in the horizontal plane, and the peak radiation gain in the vertical plane) were increased while keeping the beam tilt angles (the beam tilt angle in the horizontal plane and the beam tilt angle in the vertical plane) and the beam widths (the HPBW in the horizontal plane and the HPBW in the vertical plane), compared with the mobile communication base station antenna of FIG. 11A in Example 1.

In the mobile communication base station antenna of FIG. 13 in Example 3, although an installation occupied area was small and a similar radiation gain was provided, the beam tilt angle and the beam width were increased, compared with the mobile communication base station antenna of FIG. 11A in Example 1.

In the mobile communication base station antenna of FIG. 14A in Example 4, although the installation occupied area was small, the radiation gain was decreased and the beam tilt angle and the beam width were increased, compared with the mobile communication base station antenna of FIG. 11A in Example 1.

As described above, the radiation gains (the peak radiation gain in the horizontal plane and the peak radiation gain in the horizontal plane) were increased by arranging the antenna element pairs included in one array antenna and the antenna element pairs included in the other array antenna in the overlapped portion, to be distant from each other with the horizontal distance in the left and right direction. It is because that an interference between the antenna elements is decreased by arranging the antenna element pairs included in one array antenna and the antenna element pairs included in the other array antenna in the overlapped portion to be distant from each other with the horizontal distance in the left and right direction.

However, when a ratio of the number of the antenna element pairs in the overlapped portion to the total number of the antenna element pairs in an entire device of the mobile communication base station antenna is increased, in addition to the above arrangement of the antenna element pairs included in one array antenna and the antenna element pairs included in the other array antenna in the overlapped portion to be distant from each other with the horizontal distance in the left and right direction, the interference between the antenna elements is increased in accordance with the increase in the above ratio, thereby reducing the radiation gain. As a result, the radiation gain increased by arranging the antenna element pairs with the horizontal distance is offset slowly. Therefore, when it is desired to increase only the radiation gains without changing the other characteristics, it is unfavorable that the ratio of the number of the antenna element pairs in the overlapped portion to the total number of the antenna element pairs in the entire device of the mobile communication base station antenna is increased, in addition to the above arrangement of the antenna element pairs included in one array antenna and the antenna element pairs included in the other array antenna in the overlapped portion to be distant from each other with the horizontal distance in the left and right direction. However, it is favorable when it is desired to reduce the other characteristics such as the antenna installation occupied area even though the radiation gain is sacrificed to some extent.

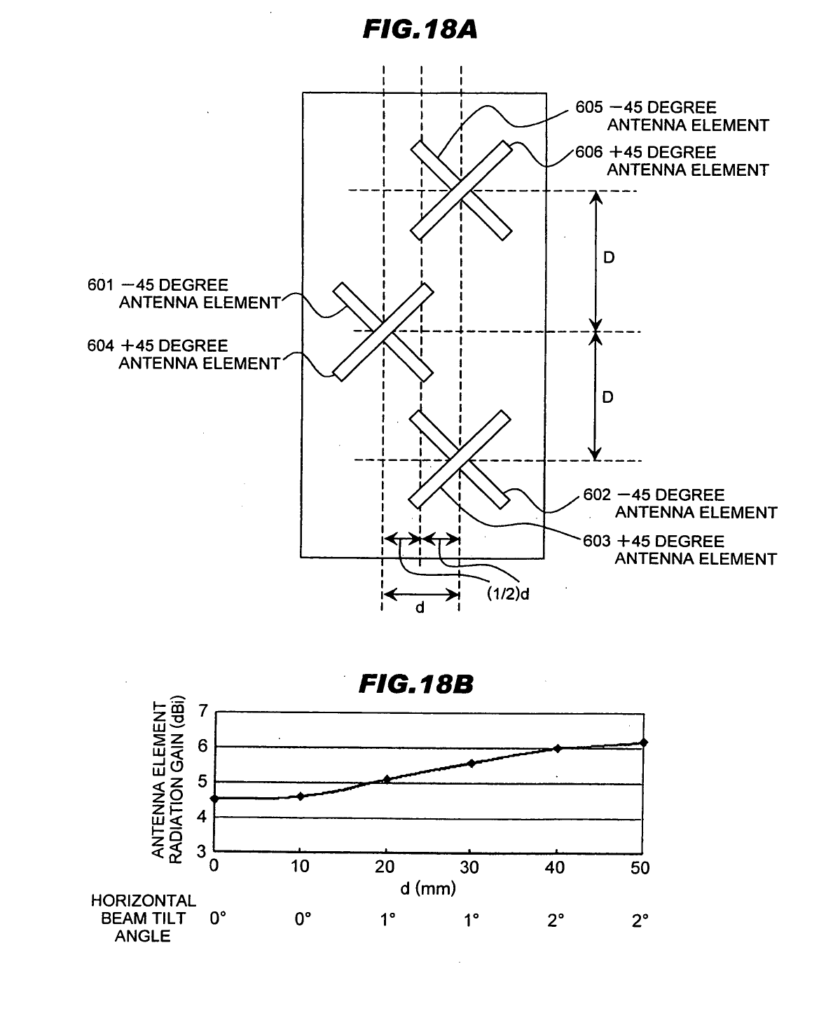

FIG. 18A is an explanatory diagram showing a method for measuring an antenna element radiation gain in the mobile communication base station antenna. FIG. 18B is a graph showing a simulation result of the antenna element radiation gain in the mobile communication base station antenna.

FIG. 18B shows simulation result showing an element radiation gain of an antenna element (single unit) in the overlapped portion. More concretely, FIG. 18 B shows the element radiation gain when the horizontal distance d in the left and right direction between the antenna element pair included in one array antenna and the antenna element pair included in the other array antenna in the overlapped portion was changed every 10 mm from 0 mm to 50 mm.

FIG. 18A shows a simulation model, in which three antenna element pairs are vertically arranged. At this time, the vertical distance D between the adjacent antenna element pairs (including +45 degree antenna elements 603, 604, 606 and −45 degree antenna elements 601, 602, 605) in the overlapped portion was 0.39λ (mm, λ=2 GHz), and the electric power was fed to only the −45 degree antenna element 601 located between two antenna element pairs. Since the element radiation gain of one antenna element is most influenced by antenna elements adjacent to the antenna element to be measured, a model including only three antenna element pairs was used as the simulation model.

As a result of the simulation, it was confirmed that the element radiation gain began to increase slowly from a point of the horizontal distance d=10 (mm). Therefore, it is preferable that the horizontal distance d is 10 mm or more. In addition, the element radiation gain is increased in accordance with the increase in the horizontal distance d. In this case, the beam tilt angle in the horizontal plane increases from a point the horizontal distance d exceeds 40 mm (not shown), and the installation occupied area increases in accordance with the increase in the horizontal distance d, so that it is not preferable that horizontal distance d is too large. Therefore, it is preferable that the horizontal distance d is 40 mm or less.

Dimensions of the antenna element may be determined appropriately in accordance with frequency and bandwidth to be used. The number of the antenna element pairs may be determined appropriately in accordance with desired antenna specification such as antenna radiation gain, antenna beam width.

### Sixth Embodiment

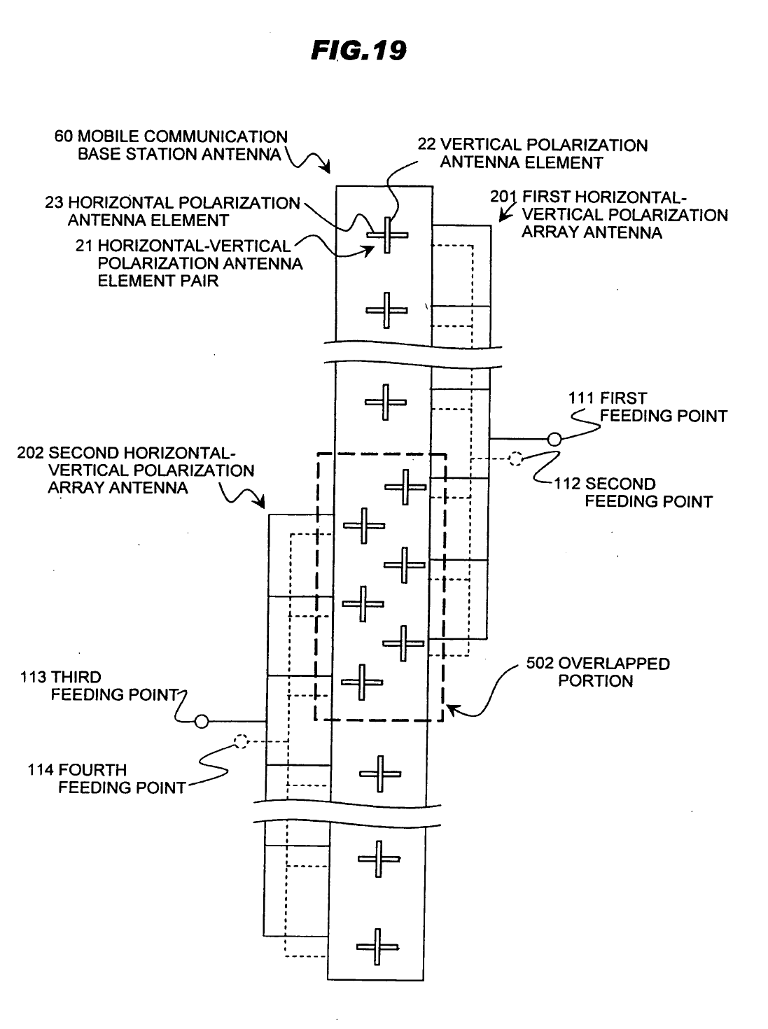

FIG. 19 is a schematic diagram of a mobile communication base station antenna 60 in the sixth preferred embodiment according to the present invention.

The mobile communication base station antenna 60 of FIG. 19 is different from the mobile communication base station antenna 20 of FIG. 6 in that antenna element pairs (horizontal-vertical polarization antenna element pairs 21) included in one of the adjacent array antennas (a first horizontal-vertical polarization array antenna 201) and antenna element pairs (horizontal-vertical polarization antenna element pairs 21) included in the other of the adjacent array antennas (a second horizontal-vertical polarization array antenna 202) may be arranged with a horizontal distance, at least in a part (an overlapped portion 502) between the first and second horizontal-vertical polarization array antennas 201, 202.

According to this structure, the element radiation gain can be increased similarly to the structure shown in FIG. 9.

### Seventh Embodiment

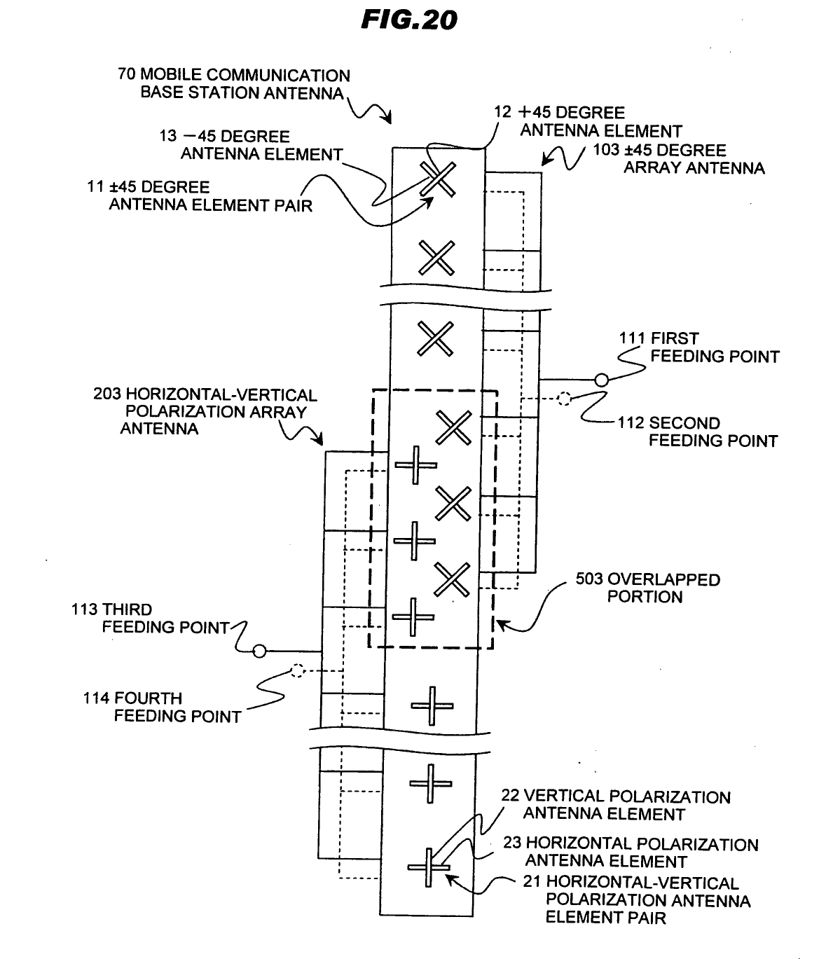

FIG. 20 is a schematic diagram of a mobile communication base station antenna 70 in the seventh preferred embodiment according to the present invention.

The mobile communication base station antenna 70 of FIG. 20 is different from the mobile communication base station antenna 30 of FIG. 7 in that antenna element pairs (±45 degree antenna element pairs 11) included in one of the adjacent array antennas (±45 degree array antenna 103) and antenna element pairs (horizontal-vertical polarization antenna element pairs 21) included in the other of the adjacent array antennas (horizontal-vertical polarization array antenna 203) may be arranged with a horizontal distance, at least in a part (an overlapped portion 503) between the ±45 degree array antenna 103 and the horizontal-vertical polarization array antenna 203.

According to this structure, the element radiation gain can be increased similarly to the structure shown in FIG. 9.

### Eighth Embodiment

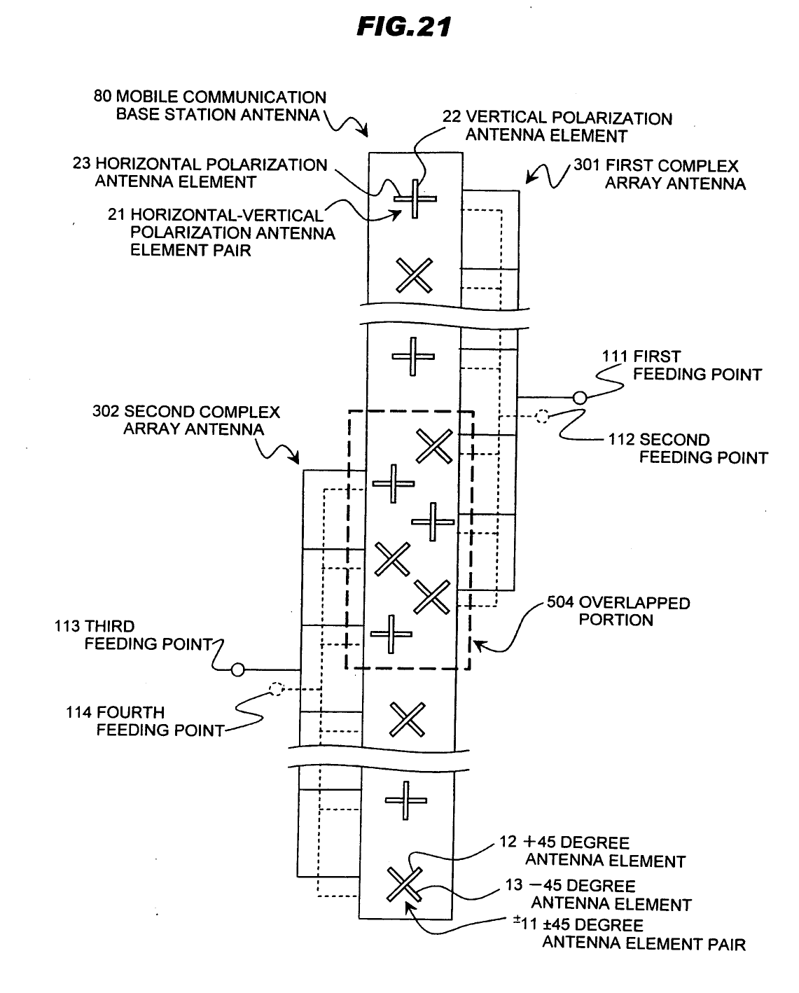

FIG. 21 is a schematic diagram of a mobile communication base station antenna 80 in the eighth preferred embodiment according to the present invention.

The mobile communication base station antenna 80 of FIG. 21 is different from the mobile communication base station antenna 40 of FIG. 8 in that antenna element pairs (±45 degree antenna element pairs 11 and horizontal-vertical polarization antenna element pairs 21) included in one of the adjacent array antennas (a first complex array antenna 301) and antenna element pairs (±45 degree antenna element pairs 11 and horizontal-vertical polarization antenna element pairs 21) included in the other of the adjacent array antennas (a second complex array antenna 302) may be arranged with a horizontal distance, in at least a part (an overlapped portion 504) between the first and second complex array antennas 301, 302.

According to this structure, the element radiation gain can be increased similarly to the structure shown in FIG. 9.

In the aforementioned embodiments, the respective array antennas are vertically arranged in the vertical plane, and the antenna element pairs included in one array antenna and the antenna element pairs included in the other array antenna are arranged to be distant from each other with the horizontal distance in the left and right direction at least in a part between the adjacent array antennas. Inasmuch as the embodiments do not deviate from a scope of the technical concept of the present invention, the antenna element pairs included in one array antenna and the antenna element pairs included in the other array antenna are arranged to be distant from each other with the horizontal distance in a backward and forward direction.

Although the invention has been described, the invention according to claims is not to be limited by the above-mentioned embodiments and examples. Further, please note that not all combinations of the features described in the embodiments and the examples are not necessary to solve the problem of the invention.

What is claimed is:

1. A mobile communication base station antenna comprising:
array antennas, each of the array antennas comprising an antenna element pair array including a plurality of antenna element pairs arranged in a vertical plane, each of the antenna element pairs comprising two antenna elements having polarization characteristics orthogonal to each other, and two feeding points for feeding an electric power to the two antenna elements respectively,
wherein the array antennas are arranged in the vertical plane,
wherein the antenna element pairs included in one of the array antennas and the antenna element pairs included in other of the array antennas are arranged alternately, at least in a part between the array antennas adjacent to each other.

2. The mobile communication base station antenna according to claim 1, wherein the antenna element pairs included in the one of the array antennas and the antenna element pairs included in the other of the array antennas are arranged alternately over an entire part between the adjacent array antennas.

3. The mobile communication base station antenna according to claim 1, wherein the antenna element comprises a horizontal-vertical polarization antenna element pair, in which one of the two antenna elements is horizontally disposed and other of the two antenna elements is vertically disposed.

4. The mobile communication base station antenna according to claim 1, wherein the antenna element comprises a ±45 degree antenna element pair, in which one of the two antenna elements is slant with +45 degree to a vertical direction and other of the two antenna elements is slant with −45 degree to the vertical direction.

5. The mobile communication base station antenna according to claim 1, wherein at least one of the array antennas comprises a horizontal-vertical polarization antenna element pair, in which one of the two antenna elements is horizontally disposed and other of the two antenna elements is vertically disposed, and other of the array antennas comprises a ±45 degree antenna element pair, in which one of the two antenna elements is slant with +45 degree to a vertical direction and other of the two antenna elements is slant with −45 degree to the vertical direction.

6. The mobile communication base station antenna according to claim 1, wherein a horizontal-vertical polarization antenna element pair, in which one of the two antenna elements is horizontally disposed and other of the two antenna elements is vertically disposed, and a ±45 degree antenna element pair, in which one of the two antenna elements is slant with +45 degree to a vertical direction and other of the two antenna elements is slant with −45 degree to the vertical direction, are arranged alternately in the array antenna.

7. The mobile communication base station antenna according to claim 1, wherein the antenna element pairs included in one of the array antennas and the antenna element pairs included in other of the array antennas are distant from each other with a horizontal distance in a left and right direction when viewed from a front side of the antenna element pairs, at least in a part between the array antennas adjacent to each other.

8. The mobile communication base station antenna according to claim 7, wherein the horizontal distance is 10 mm or more and 40 mm or less.

9. The mobile communication base station antenna according to claim 1, wherein the antenna element comprises a half wave dipole antenna.

10. The mobile communication base station antenna according to claim 1, wherein the antenna element comprises a patch antenna.
